(19) United States
(12) Patent Application Publication
(10) Pub. No.: US 2011/0234365 A1
(43) Pub. Date: Sep. 29, 2011

(54) CHIP RESISTOR HAVING LOW RESISTANCE AND METHOD FOR MANUFACTURING THE SAME

(75) Inventors: CHIH-CHUNG YANG, Kaohsiung (TW); MEI-LING LIN, Kaohsiung (TW); IAN-WEI CHIAN, Kaohsiung (TW); YA-TANG HU, Kaohsiung (TW); CHIN-YUAN TSENG, Kaohsiung (TW)

(73) Assignee: YAGEO CORPORATION, Kaohsiung (TW)

(21) Appl. No.: 13/026,056

(22) Filed: Feb. 11, 2011

(30) Foreign Application Priority Data
Mar. 23, 2010 (TW) 099108539

(51) Int. Cl. H01C 1/012; C25D 7/00

(52) U.S. Cl. 338/309; 205/184

(57) ABSTRACT

The present invention relates to a chip resistor having low resistance and a method for manufacturing the same. The chip resistor includes a substrate, a resistive layer, a pair of conducting layers and at least one protective layer. The substrate has a first surface. The resistive layer is disposed on the first surface of the substrate. The conducting layers are disposed adjacent to the first surface of the substrate. The at least one protective layer is disposed on the resistive layer or the conducting layers. As a result, the resistive layer has a precise pattern, and the duration of sputtering is reduced, thereby improving yield rate and efficiency while reducing manufacturing cost.

### BACKGROUND OF THE INVENTION

1. Field of the Invention

The present invention relates to a chip resistor and a method for manufacturing the same, and more particularly to a chip resistor having low resistance and a method for manufacturing the same.

2. Description of the Related Art

As shown in FIG. 1, a conventional chip resistor 1 is a passive component attached to a printed circuit board. The method for manufacturing a conventional chip resistor 1 is described below. First, a ceramic substrate 11 having a second surface 111, a pair of side surfaces 112 and a first surface 113 is provided. Then, a pair of bottom electrodes 13 are formed on the second surface 111 of the substrate 11. Each of the bottom electrodes 13 has an outer surface 131 aligned with the side surfaces 112 of the substrate 11. A resistive layer 14 is formed on a central area of the substrate 11, and the resistive layer 14 has a pair of ends 141.

A pair of conducting layers 12 are formed on the first surface 113 of the substrate 11. Each of the conducting layers 12 has an outer surface 122 aligned with the side surfaces 112 of the substrate 11. Moreover, each of the conducting layers 12 has an internal part 121 and an outer surface 122. The conducting layers 12 extend over the resistive layer 14, so that the internal part 121 of the conducting layers 12 overlaps the ends 141 of the resistive layer 14.

Moreover, a first overcoat 15 is formed on the resistive layer 14, and a second overcoat 16 is formed on the first overcoat 15. A pair of side electrodes 17 are formed on the side surfaces 112 of the substrate 11, the outer surface 122 of the conducting layers 12 and the outer surface 131 of the bottom electrodes 13, so that the side electrodes 17 electrically connect the conducting layers 12 and the bottom electrodes 13. Further, a pair of first electroplating layers 18 are electroplated so as to cover the bottom electrodes 13, the conducting layers 12 and the side electrodes 17, and a pair of second electroplating layers 19 are electroplated so as to cover the first electroplating layers 18. Meanwhile, the conventional chip resistor 1 is formed.

In a thick film chip resistor, a resistor paste is screen printed on the ceramic substrate 11, so as to form the resistive layer 14. Then, the conventional thick film chip resistor undergoes a drying process and a sintering process. In order to reduce the resistance of the conventional thick film chip resistor to about 100 m Ω, Ag, Pd or Ag—Pd alloy are usually used in the resistor paste. However, the temperature coefficient of resistance (TCR) of Ag or Pd is about 600 ppm/° C. to about 1000 ppm/° C. Therefore, the temperature coefficient of resistance (TCR) of the conventional thick film chip resistor can not meet the requirement of about 50 ppm/° C. or lower than 50 ppm/° C. Moreover, the resistance of the conventional thick film chip resistor is determined by the size of the printing pattern, so the size of the printing pattern limits the minimum resistance.

In a conventional thin film chip resistor, on the other hand, the resistive layer 14 is formed by sputtering a target material on the ceramic substrate 11. First, a mask is formed on the first surface 113 of the substrate 11, and is used to define the pattern of the resistive layer 14. Specifically, the mask is formed along the periphery of the first surface 113 of the substrate 11, so as to expose part of the first surface 113 of the substrate 11, and preferably expose the central pattern of the first surface 113 of the substrate 11. Then, sputtering is conducted on the above-mentioned mask and the whole first surface 113 of the substrate 11, and the resistive layer 14 having the ends 141 is formed. Then, the mask is removed by brushing and washing. The sputtered resistive layer 14 that directly contacts the ceramic substrate 11 remains because of the strong adhesion with the ceramic substrate 11, and the sputtered resistive layer 14 disposed on the top of the mask is easily removed by brushing and washing. Therefore, the pattern of the resistive layer 14 corresponds to the pattern formed by the mask. Then, the conventional thin film chip resistor undergoes a laser trimming process and annealing process. In order to reduce the resistance of the conventional thin film chip resistor, people familiar with this technology usually adjust the target material, the pattern or the parameter of sputtering. A general method for reducing resistance is to extend the duration of sputtering and therefore increase the thickness of the resistive layer 14. For example, in order to reduce the resistance to about 100 mΩ, the duration of sputtering is about 1 hour; in order to reduce the resistance to about 10 mΩ, the duration of sputtering is about 5 hours or more than 5 hours. However, long duration of sputtering is costly, and is not acceptable for mass production. Moreover, sputtering for a long duration will cause the heat accumulated on the ceramic substrate 11 to lead to interaction between the resistive layer 14 and the mask (not shown). The interaction distorts the pattern, and therefore the resistance change is increased and the yield rate is reduced.

Therefore, it is necessary to provide a chip resistor having low resistance and a method for manufacturing the same to solve the above problems.

### SUMMARY OF THE INVENTION

The present invention is directed to a chip resistor having low resistance. The chip resistor comprises a substrate, a resistive layer, a pair of conducting layers and at least one protective layer. The substrate has a first surface. The resistive layer is disposed on the first surface of the substrate. The conducting layers are disposed adjacent to the first surface of the substrate. The at least one protective layer is disposed on the resistive layer or the conducting layers.

The present invention is further directed to a method for manufacturing a chip resistor having low resistance. The method comprises the following steps: (a) providing a substrate having a first surface; (b) sputtering a resistive layer on the first surface of the substrate; (c) electroplating a pair of conducting layers adjacent to the first surface of the substrate; and (d) forming at least one protective layer on the resistive layer or the conducting layers.

As a result, the resistive layer has a precise pattern, and the duration of sputtering is reduced, thereby improving yield rate and efficiency while reducing manufacturing cost.

### BRIEF DESCRIPTION OF THE DRAWINGS

FIG. 1 is a cross-sectional view of a conventional chip resistor;

FIGS. 2 to 20 are schematic views of a method for manufacturing a chip resistor having low resistance according to a first embodiment of the present invention;

FIG. 21 is a cross-sectional view of a chip resistor having low resistance according to a second embodiment of the present invention; and

FIG. 22 is a cross-sectional view of a chip resistor having low resistance according to a third embodiment of the present invention.

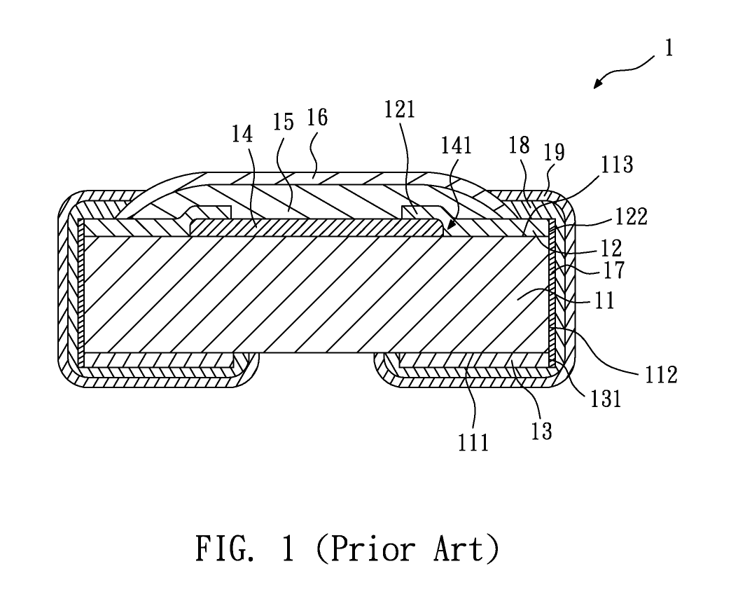

### DETAILED DESCRIPTION OF THE INVENTION

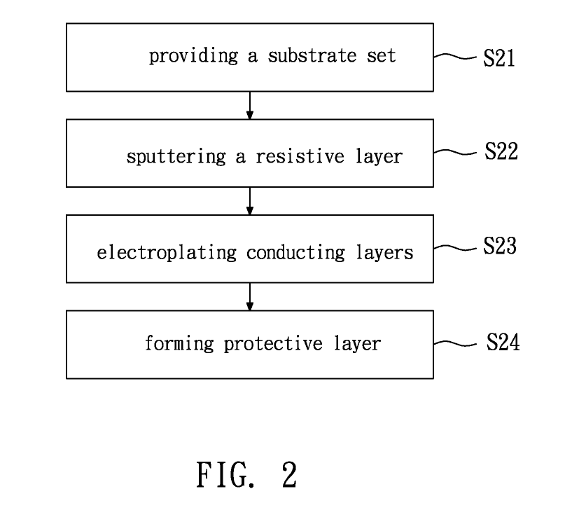

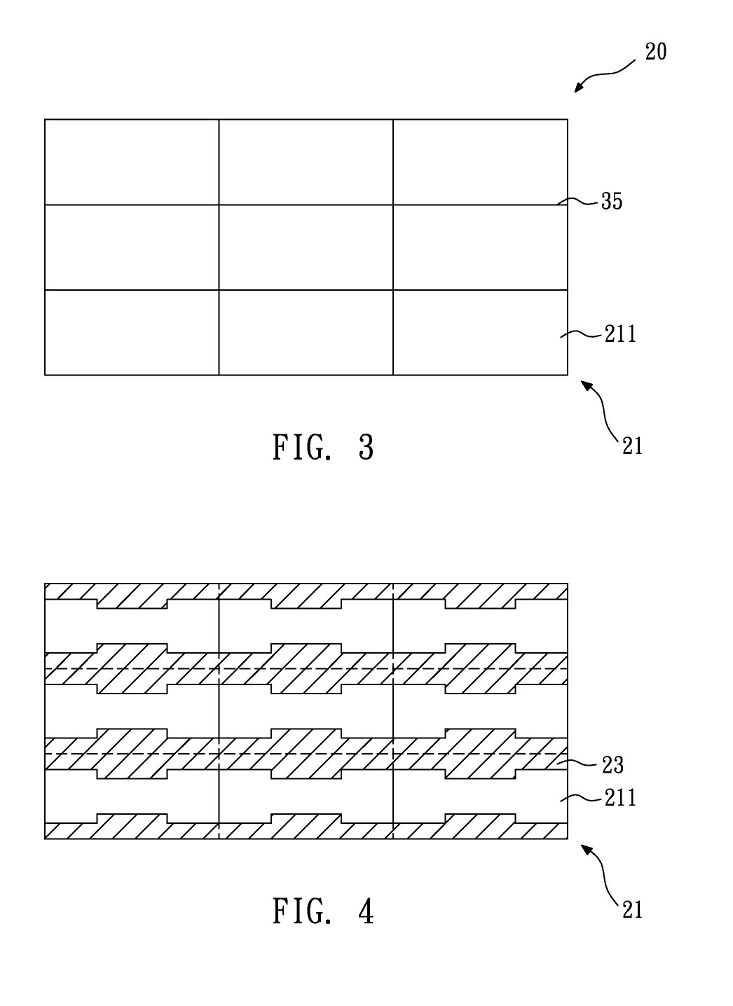

FIG. 2 shows a flow chart of a method for manufacturing a chip resistor having low resistance according to a first embodiment of the present invention. First, referring to Step S21 of FIG. 2 and FIG. 3, a substrate set 20 is provided. The substrate set 20 has a plurality of substrates 21 and a plurality of stripping lines 35. The stripping lines 35 define the substrates 21. Each of the substrates 21 has a first surface 211. Preferably, the material of each of the substrates 21 is aluminum oxide, zirconium oxide or aluminum nitride.

Then, referring to FIG. 6, preferably, an under layer 22 is formed on the first surface 211 of each of the substrates 21. In the embodiment, the under layer 22 is a Ni—Cr alloy, and comprises about 80% nickel (Ni) and about 20% chromium (Cr), preferably, 80% nickel (Ni) and 20% chromium (Cr). However, in other embodiment, the under layer 22 may be a Ni—Cr—Si alloy, and comprise about 50% to about 55% nickel (Ni), about 33% to about 45% chromium (Cr), and about 5% to about 12% silicon (Si), preferably, 50% to 55% nickel (Ni), 33% to 45% chromium (Cr), and 5% to 12% silicon (Si).

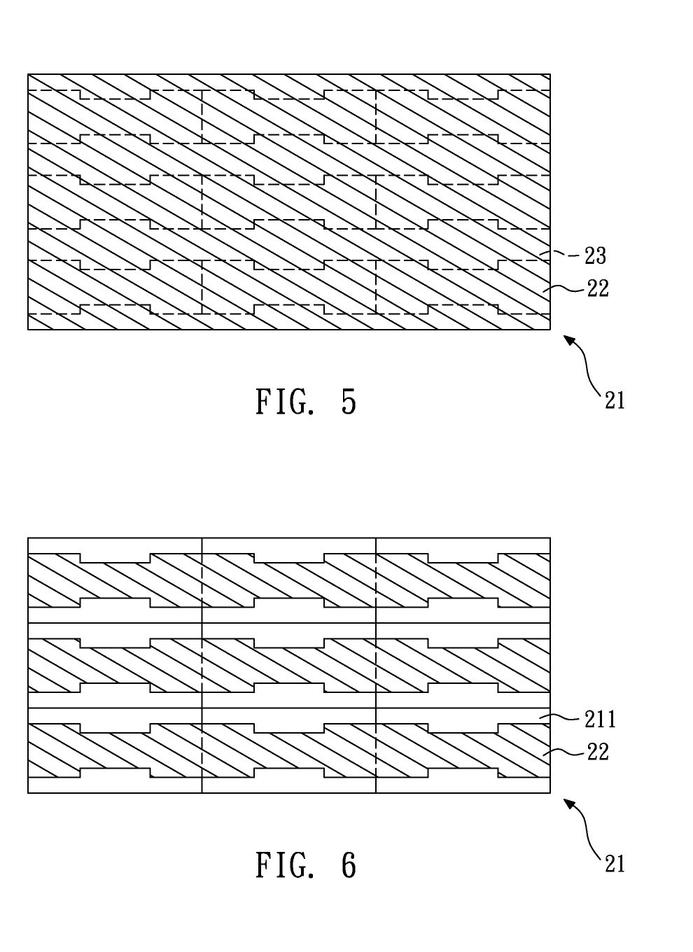

The method for forming the under layer 22 is described below. First, referring to FIG. 4, a first mask layer 23 is formed on the first surface 211 of each of the substrates 21, wherein the first mask layer 23 exposes part of the first surface 211 of each of the substrates 21. Then, referring to FIG. 5, the under layer 22 is formed on the first surface 211 of each of the substrates 21 and the first mask layer 23. The under layer 22 completely covers the first surface 211 of each of the substrates 21 and the first mask layer 23. Last, referring to FIG. 6, the first mask layer 23 (FIG. 4 and FIG. 5) and part of the under layer 22 disposed on the first mask layer 23 are removed.

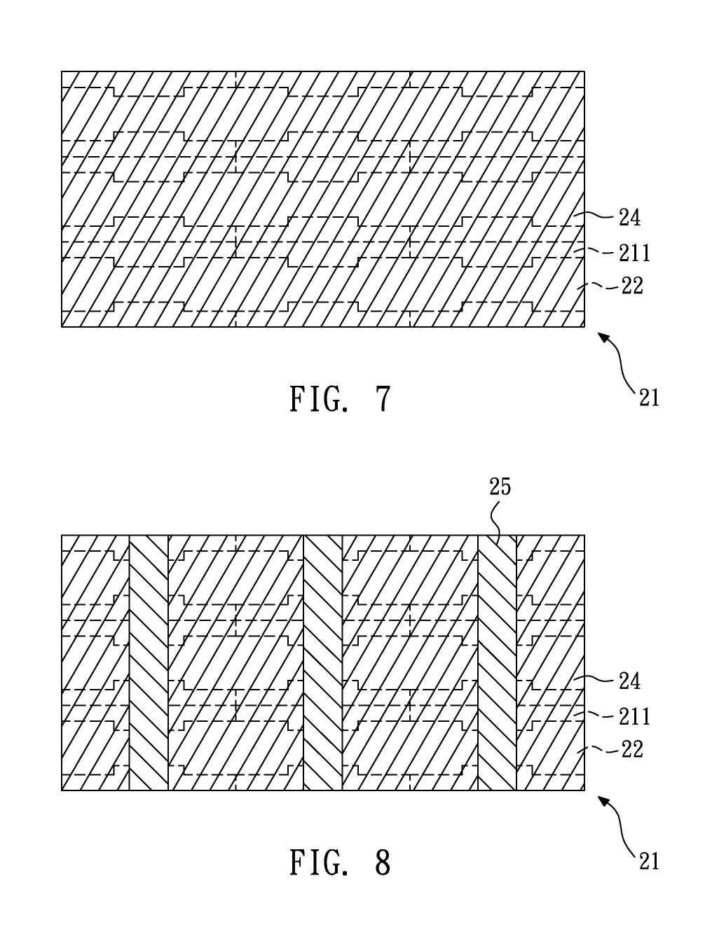

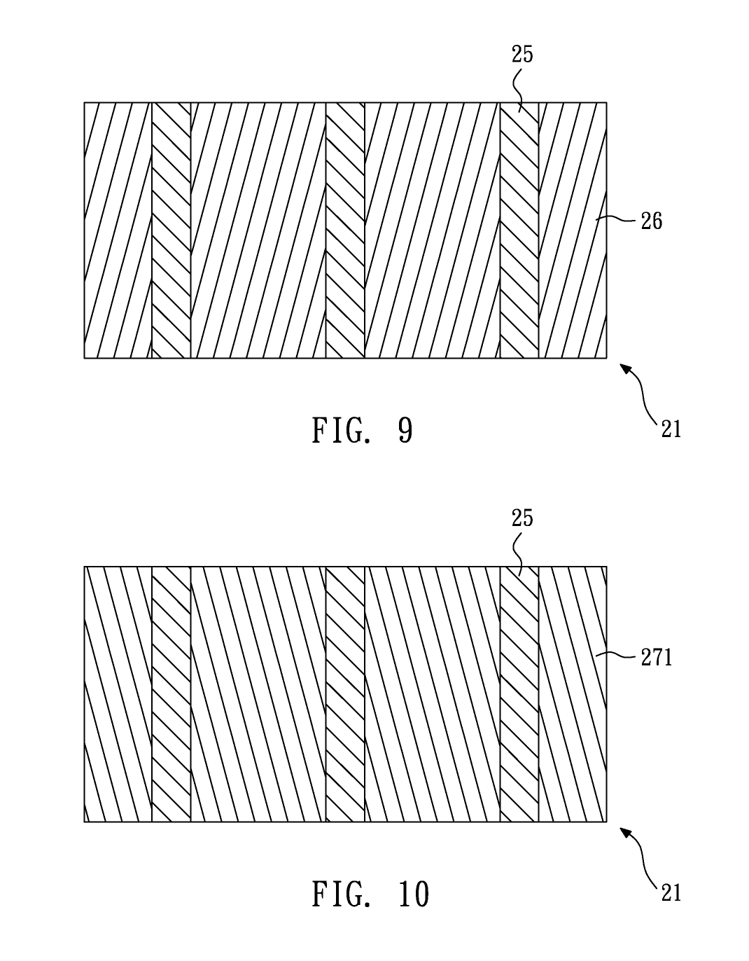

Referring to Step S22 of FIG. 2 and FIG. 7, a resistive layer 24 is sputtered on the first surface 211 of each of the substrates 21, the resistive layer 24 completely covering the first surface 211 of each of the substrates 21 and the under layer 22. In the embodiment, the resistive layer 24 is an alloy comprising copper (Cu) and nickel (Ni). However, in other embodiments, the material of the resistive layer 24 may comprise copper (Cu) and manganese (Mn). Referring to FIG. 8, preferably, a second mask layer 25 is formed on the resistive layer 24, part of which is covered by the second mask layer 25.

Referring to Step S23 of FIG. 2 and FIG. 9, a pair of conducting layers 26 are electroplated adjacent to the first surface 211 of each of the substrates 21. In the embodiment, the conducting layers 26 are disposed on the resistive layer 24, and the material of the conducting layers 26 is copper (Cu). Referring to Step S24 of FIG. 2 and FIG. 11, at least one protective layer 27 is formed on the resistive layer 24 or the conducting layers 26. In the embodiment, a plurality of protective layers 27 are formed on the conducting layers 26. The protective layers 27 comprise a first protective layer 271 and a second protective layer 272. The first protective layer 271 is a passivation layer, and the second protective layer 272 is an anti-oxidation layer.

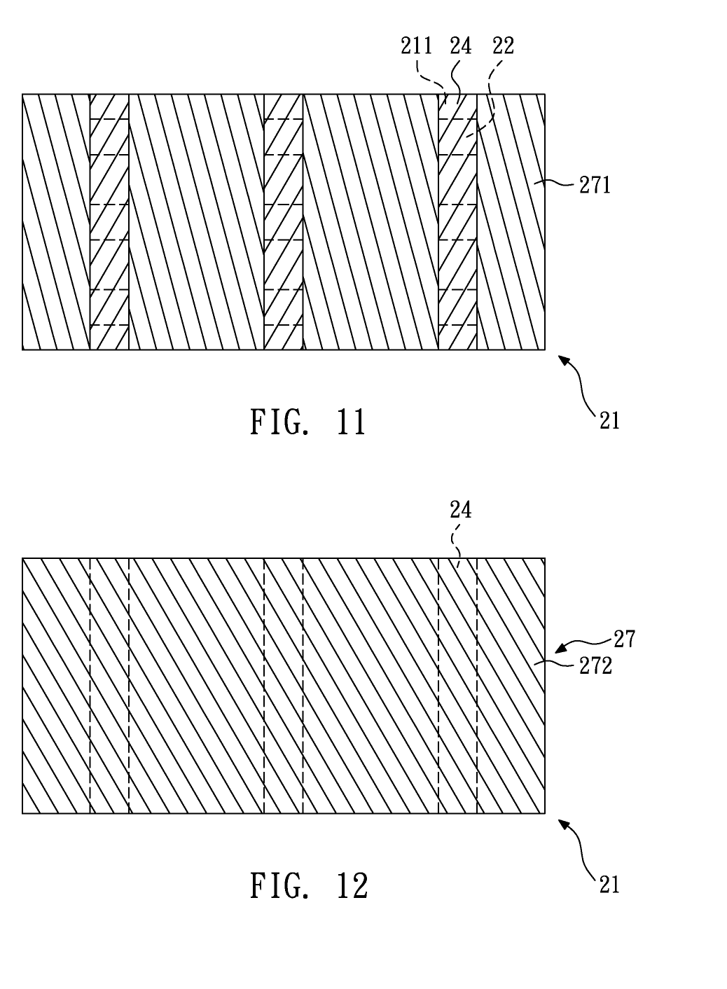

The method for forming the first protective layer 271 and the second protective layer 272 is described below. Referring to FIG. 10, the first protective layer 271 is formed on the conducting layers 26; the material of the first protective layer 271 is nickel (Ni). Referring to FIG. 11, the second mask layer 25 (FIG. 10) is removed. Referring to FIG. 12, the second protective layer 272 is formed on the first protective layer 271 and the resistive layer 24. The second protective layer 272 completely covers the first protective layer 271 and the resistive layer 24. In the embodiment, the material of the second protective layer 272 comprises nickel (Ni) and chromium (Cr), the second protective layer 272 is a Ni—Cr alloy, and comprises about 80% nickel (Ni) and about 20% chromium (Cr), preferably, 80% nickel (Ni) and 20% chromium (Cr). However, in other embodiments, the material of the second protective layer 272 further comprises silicon (Si), the second protective layer 272 is a Ni—Cr—Si alloy, and comprises about 50% to about 55% nickel (Ni), about 33% to about 45% chromium (Cr), and about 5% to about 12% silicon (Si), preferably, 50% to 55% nickel (Ni), 33% to 45% chromium (Cr), and 5% to 12% silicon (Si).

However, in other embodiments, it is acceptable to form a protective layer 27 on only the resistive layer 24 or the conducting layers 26. For example, after the first protective layer 271 (that is, the passivation layer) is formed, the second protective layer 272 (that is, the anti-oxidation layer) need not be formed. Alternatively, after the conducting layer 26 is formed, the first protective layer 271 (that is, the passivation layer) need not to be formed; instead, the second protective layer 272 (that is, the anti-oxidation layer) is formed directly on the conducting layers 26 and the resistive layer 24.

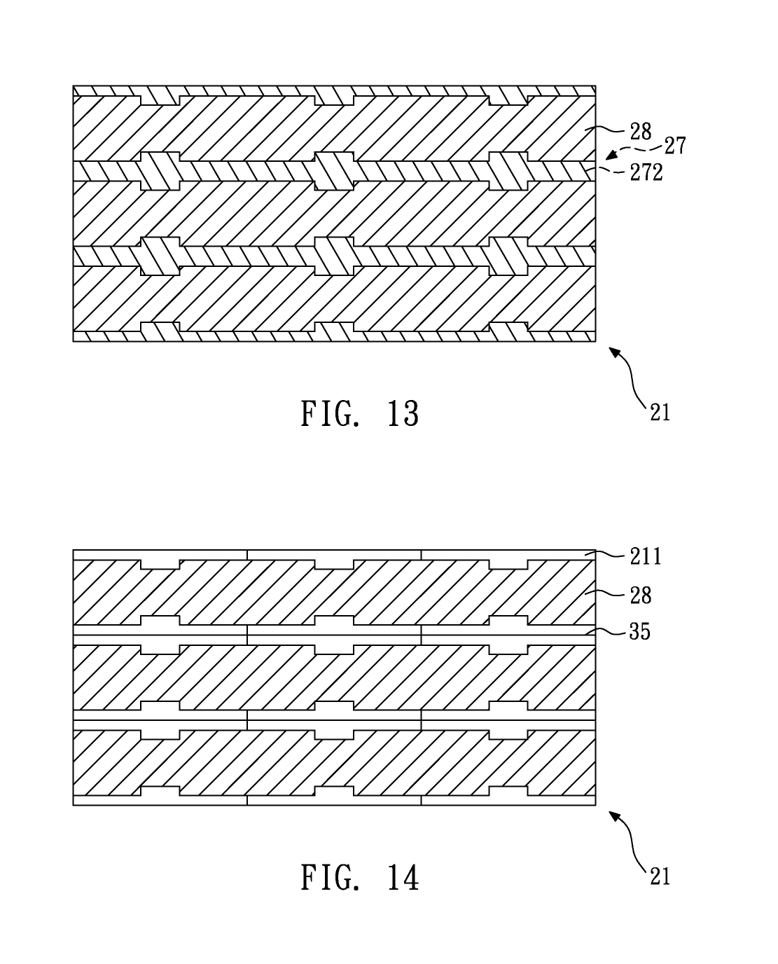

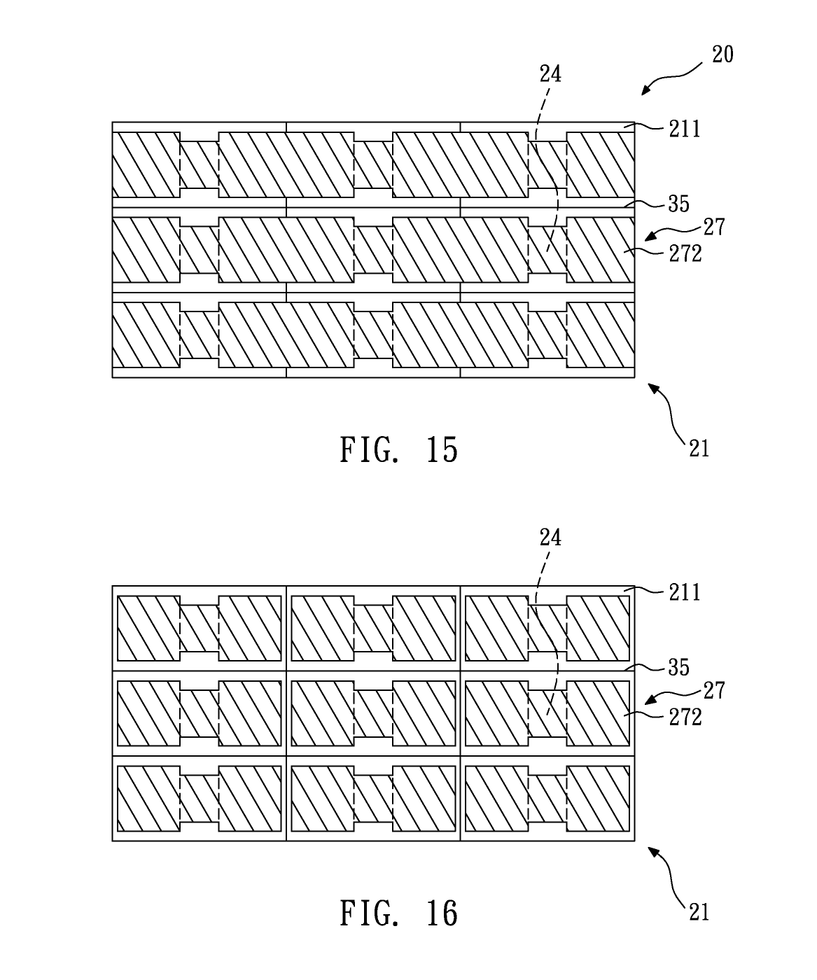

Preferably, referring to FIG. 13, a third mask layer 28 is formed on the protective layers 27, such that the third mask layer 28 covers part of the second protective layer 272. Then, referring to FIG. 14, part of the resistive layer 24, the conducting layer 26 and the protective layers 27 are removed by etching, so as to expose the first surface 211 of each of the substrates 21. Then, referring to FIG. 15, the third mask layer 28 (FIG. 13) is removed first, and then the resistive layer 24, the conducting layers 26 and the protective layers 27 are heated at a temperature of about 200° C. to about 600° C. at the same time, preferably, at a temperature of 200° C. to 600° C. However, in other embodiments, it is also acceptable that the resistive layer 24 is heated at a temperature of about 200° C. to about 600° C., preferably, at a temperature of 200° C. to 600° C., right after the resistive layer 24 is formed. The conducting layers 26 are heated at a temperature of about 150° C. to about 250° C., preferably, at a temperature of 150° C. to 250° C., right after the conducting layer 26 is formed. Then, the resistance of the substrate set 20 is measured from two ends of the substrate set 20.

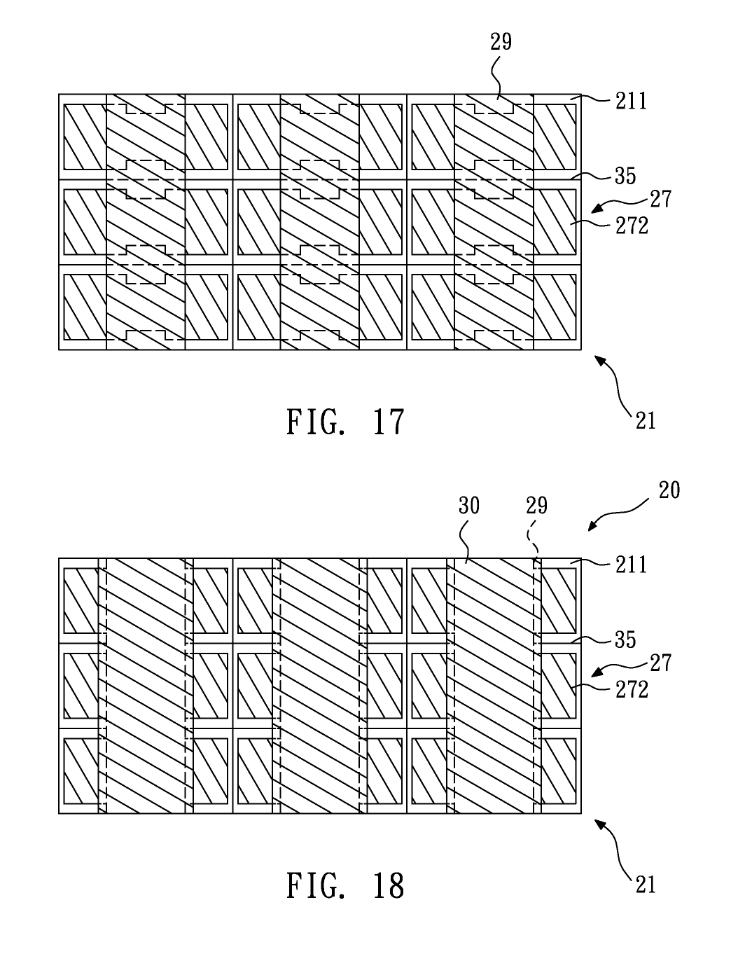

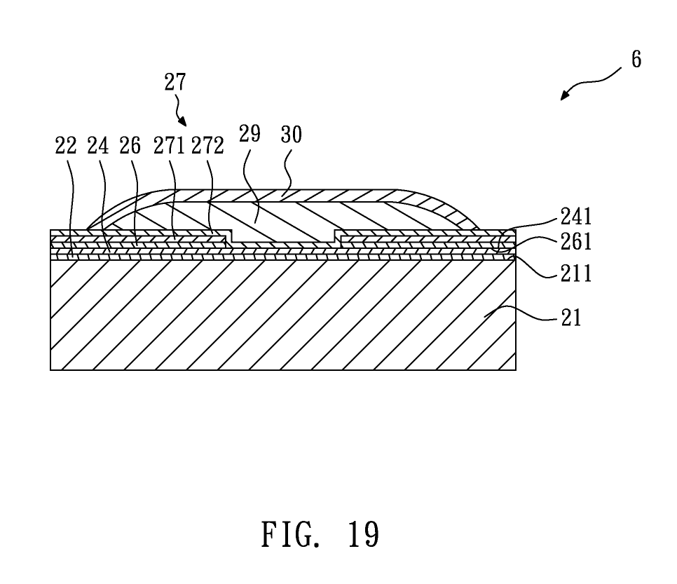

Referring to FIG. 16, a laser trimming process is conducted. The under layer 22, the resistive layer 24, the conducting layers 26, the first protective layer 271 and the second protective layer 272 disposed near the stripping lines 35 are removed, so as to completely expose the stripping lines 35. Referring to FIG. 17, a first overcoat 29 is formed on the protective layers 27. Referring to FIG. 18, a second overcoat 30 is formed on the first overcoat 29. Then, a singulation process is conducted; that is, the substrates 21 are separated along the stripping lines 35 of the substrate set 20, so as to form a plurality of semi-finished products 6, as shown in the cross-sectional view of FIG. 19.

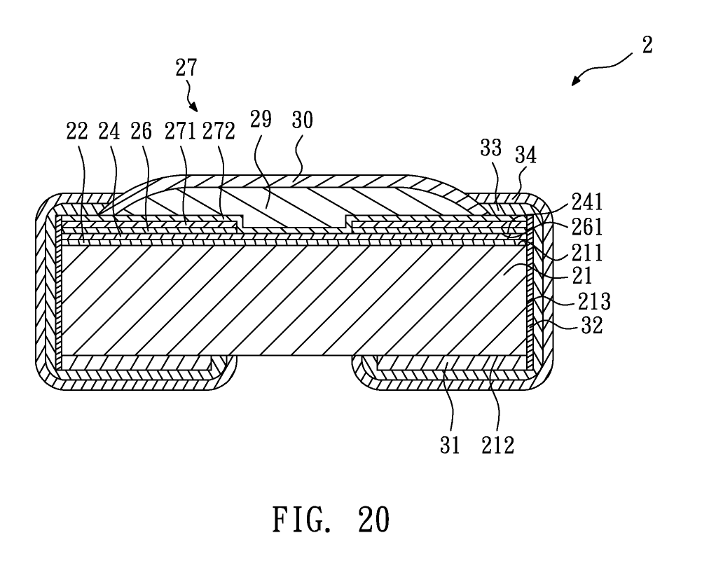

Referring to FIG. 20, a pair of bottom electrodes 31 are formed on a second surface 212 of the substrate 21. Then, a pair of side electrodes 32 are formed on two side surfaces 213 of the substrate 21, so that the side electrodes 32 electrically connect the conducting layers 26 and the bottom electrodes 31. Then, a pair of first electroplating layers 33 are electroplated so as to cover the bottom electrodes 31, the conducting layer 26 and the side electrodes 32. The material of the first electroplating layers 33 is nickel (Ni). Then, a pair of second electroplating layers 34, the material of which is stannum (Sn), are electroplated so as to cover the first electroplating layers 33, thereby forming a chip resistor 2 having low resistance according to the first embodiment of the present invention. In the present invention, by utilizing sputtering and etching, the resistive layer 24 has a precise pattern, and the duration of sputtering is reduced, thereby improving yield rate and efficiency while reducing manufacturing cost.

FIG. 20 shows a cross-sectional view of a chip resistor having low resistance according to the first embodiment of the present invention. The chip resistor 2 comprises a substrate 21, a resistive layer 24, a pair of conducting layers 26 and at least one protective layer 27. In the embodiment, the chip resistor 2 further comprises an under layer 22, a first overcoat 29, a second overcoat 30, a pair of bottom electrodes 31, a pair of side electrodes 32, a pair of first electroplating layers 33 and a pair of second electroplating layers 34.

The substrate 21 has a first surface 211. In the embodiment, the material of the substrate 21 is aluminum oxide, zirconium oxide or aluminum nitride. The under layer 22 is disposed on the first surface 211 of the substrate 21. In the embodiment, the under layer 22 is a Ni—Cr alloy, and comprises about 80% nickel (Ni) and about 20% chromium (Cr), preferably, 80% nickel (Ni) and 20% chromium (Cr). However, in other embodiment, the under layer 22 may be a Ni—Cr—Si alloy, and comprise about 50% to about 55% nickel (Ni), about 33% to about 45% chromium (Cr), and about 5% to about 12% silicon (Si), preferably, 50% to 55% nickel (Ni), 33% to 45% chromium (Cr), and 5% to 12% silicon (Si).

The resistive layer 24 is disposed on the first surface 211 of the substrate 21. In the embodiment, the resistive layer 24 is disposed on the under layer 22. The resistive layer 24 has a top surface 241, each of the conducting layers 26 has a bottom surface 261, and the bottom surface 261 of each of the conducting layers 26 directly contacts the top surface 241 of the resistive layer 24. Moreover, the resistive layer 24 is an alloy, and the material of the resistive layer 24 comprises copper (Cu) and nickel (Ni). However, in other embodiments, the material of the resistive layer 24 may comprise copper (Cu) and manganese (Mn). The conducting layers 26 are disposed adjacent to the first surface 211 of the substrate 21. In the embodiment, the material of the conducting layer 26 is copper (Cu).

The at least one protective layer 27 is disposed on the resistive layer 24 or the conducting layers 26. In the embodiment, the chip resistor 2 has a plurality of protective layers 27, and the protective layers 27 comprise a first protective layer 271 and a second protective layer 272. The first protective layer 271 is a passivation layer, and is disposed only on the conducting layers 26. The second protective layer 272 is an anti-oxidation layer, and is disposed on the first protective layer 271 and the resistive layer 24. The material of the first protective layer 271 is Ni. The material of the second protective layer 272 is a Ni—Cr alloy comprising about 80% nickel (Ni) and about 20% chromium (Cr), preferably, 80% nickel (Ni) and 20% chromium (Cr).

However, in other embodiments, the material of the second protective layer 272 may further comprise silicon (Si). The second protective layer 272 is a Ni—Cr—Si alloy, and comprises about 50% to about 55% nickel (Ni), about 33% to about 45% chromium (Cr), and about 5% to about 12% silicon (Si), preferably, 50% to 55% nickel (Ni), 33% to 45% chromium (Cr), and 5% to 12% silicon (Si). In the embodiment, the first overcoat 29 is disposed on the protective layers 27, and the second overcoat 30 is disposed on the first overcoat 29. The bottom electrodes 31 are disposed on a second surface 212 of the substrate 21. The side electrodes 32 are disposed on two side surfaces 213 of the substrate 21, and electrically connect the conducting layers 26 and the bottom electrodes 31. The first electroplating layers 33 cover the bottom electrodes 31, the conducting layer 26 and the side electrodes 32. The second electroplating layers 34 cover the first electroplating layers 33.

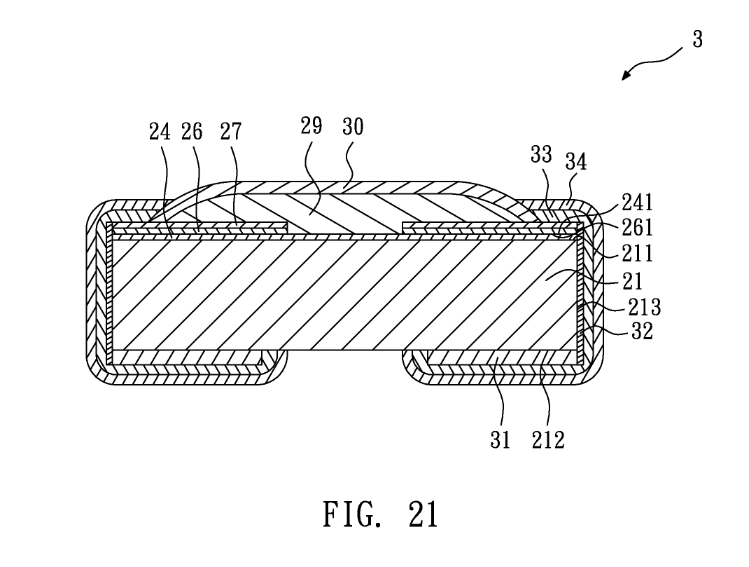

FIG. 21 shows a cross-sectional view of a chip resistor having low resistance according to a second embodiment of the present invention. The chip resistor 3 according to the second embodiment is substantially the same as the chip resistor 2 according to the first embodiment, and the same elements are designated by the same reference numbers. The difference between the chip resistor 3 and the chip resistor 2 is that in the embodiment, the chip resistor 3 does not comprise the under layer 22 (FIG. 20), and the resistive layer 24 directly contacts the first surface 211 of the substrate 21. Moreover, in the embodiment, only a protective layer 27 is formed; the protective layer 27 is a passivation layer, and is disposed on the conducting layers 26. The material of the protective layer 27 is nickel (Ni).

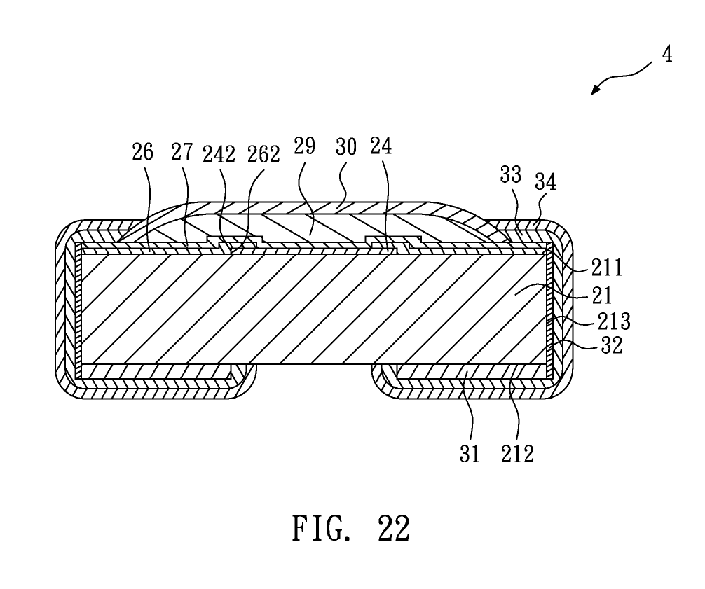

FIG. 22 shows a cross-sectional view of a chip resistor having low resistance according to a third embodiment of the present invention. The chip resistor 4 according to the third embodiment is substantially the same as the chip resistor 3 according to the second embodiment, and the same elements are designated by the same reference numbers. The difference between the chip resistor 4 and the chip resistor 3 is that the resistive layer 24 has a side surface 242, each of the conducting layers 26 has an inner side surface 262, and the inner side surface 262 of each of the conducting layers 26 directly contacts the side surface 242 of the resistive layer 24. In the embodiment, the conducting layers 26 further extend over the resistive layer 24. In the embodiment, the protective layer 27 is an anti-oxidation layer, and is disposed on the conducting layers 26 and the resistive layer 24. The material of the protective layer 27 comprises nickel (Ni) and chromium (Cr), the protective layer 27 is a Ni—Cr alloy, and comprises about 80% nickel (Ni) and about 20% chromium (Cr), preferably, 80% nickel (Ni) and 20% chromium (Cr). However, in other embodiment, the material of the protective layer 27 further comprises silicon (Si). The protective layer 27 is a Ni—Cr—Si alloy, and comprises about 50% to about 55% nickel (Ni), about 33% to about 45% chromium (Cr), and about 5% to about 12% silicon (Si), preferably, 50% to 55% nickel (Ni), 33% to 45% chromium (Cr), and 5% to 12% silicon (Si).

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined by the appended claims.

What is claimed is:

1. A chip resistor having low resistance, comprising:
a substrate, having a first surface;
a resistive layer, disposed on the first surface of the substrate;
a pair of conducting layers, disposed adjacent to the first surface of the substrate; and
at least one protective layer, disposed on the resistive layer or the conducting layers.

2. The chip resistor as claimed in claim 1, wherein the resistive layer is an alloy, the material of the resistive layer comprises copper (Cu), and the material of the conducting layer is copper (Cu).

3. The chip resistor as claimed in claim 1, wherein the resistive layer has a top surface, each of the conducting layers has a bottom surface, and the bottom surface of each of the conducting layers directly contacts the top surface of the resistive layer.

4. The chip resistor as claimed in claim 1, wherein the resistive layer has a side surface, each of the conducting layers has an inner side surface, and the inner side surface of each of the conducting layers directly contacts the side surface of the resistive layer.

5. The chip resistor as claimed in claim 1, wherein the protective layer is a passivation layer, and is disposed on the conducting layers, and the material of the protective layer is nickel (Ni).

6. The chip resistor as claimed in claim 1, wherein the protective layer is an anti-oxidation layer, and is disposed on the conducting layers and the resistive layer, and the material of the protective layer comprises nickel (Ni) and chromium (Cr).

7. The chip resistor as claimed in claim 6, wherein the protective layer is a Ni—Cr alloy, and comprises 80% nickel (Ni) and 20% chromium (Cr).

8. The chip resistor as claimed in claim 6, wherein the protective layer is a Ni—Cr—Si alloy, and comprises 50% to 55% nickel (Ni), 33% to 45% chromium (Cr), and 5% to 12% silicon (Si).

9. The chip resistor as claimed in claim 1, further comprising an under layer disposed on the first surface of the substrate, wherein the resistive layer is disposed on the under layer.

10. The chip resistor as claimed in claim 9, wherein the under layer is a Ni—Cr alloy, and comprises 80% nickel (Ni) and 20% chromium (Cr).

11. The chip resistor as claimed in claim 9, wherein the under layer is a Ni—Cr—Si alloy, and comprises 50% to 55% nickel (Ni), 33% to 45% chromium (Cr), and 5% to 12% silicon (Si).

12. A method for manufacturing a chip resistor having low resistance, comprising:
(a) providing a substrate having a first surface;
(b) sputtering a resistive layer on the first surface of the substrate;
(c) electroplating a pair of conducting layers adjacent to the first surface of the substrate; and
(d) forming at least one protective layer on the resistive layer or the conducting layers.

13. The method as claimed in claim 12, further comprising a step of forming an under layer on the first surface of the substrate in step (a), and in step (b), the resistive layer is disposed on the under layer.

14. The method as claimed in claim 13, wherein the under layer is a Ni—Cr alloy, and comprises 80% nickel (Ni) and 20% chromium (Cr).

15. The method as claimed in claim 13, wherein the under layer is a Ni—Cr—Si alloy, and comprises 50% to 55% nickel (Ni), 33% to 45% chromium (Cr), and 5% to 12% silicon (Si).

16. The method as claimed in claim 12, wherein in step (b), the resistive layer is an alloy, and the material of the resistive layer comprises copper (Cu), and in step (c), the material of the conducting layers is copper (Cu).

17. The method as claimed in claim 12, wherein in step (d), the protective layer is a passivation layer, and is disposed on the conducting layers, and the material of the protective layer is nickel (Ni).

18. The method as claimed in claim 12, wherein in step (d), the protective layer is an anti-oxidation layer, and is disposed on the conducting layers and the resistive layer, and the material of the protective layer comprises nickel (Ni) and chromium (Cr).

19. The method as claimed in claim 18, wherein the protective layer is a Ni—Cr alloy, and comprises 80% nickel (Ni) and 20% chromium (Cr).

20. The method as claimed in claim 18, wherein the material of the protective layer further comprises silicon (Si), the protective layer is a Ni—Cr—Si alloy, and comprises 50% to 55% nickel (Ni), 33% to 45% chromium (Cr), and 5% to 12% silicon (Si).

21. The method as claimed in claim 12, wherein step (d) comprises:
(d1) forming a first protective layer on the conducting layers, wherein the first protective layer is a passivation layer, and the material of the first protective layer is nickel (Ni); and
(d2) forming a second protective layer on the first protective layer and the resistive layer, wherein the second protective layer is an anti-oxidation layer, and the material of the second protective layer comprises nickel (Ni) and chromium (Cr).
